(19) United States
(12) Patent Application Publication
(10) Pub. No.: US 2007/0097834 A1
(43) Pub. Date: May 3, 2007

(54) OPTICAL RECORDING DISK APPARATUS

(75) Inventor: Hiroshi Sakai, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: NIDEC Sankyo Corporation

(21) Appl. No.: 11/553,079

(22) Filed: Oct. 26, 2006

(30) Foreign Application Priority Data
Oct. 27, 2005 (JP) 2005-312643

(51) Int. Cl. G11B 7/135

(52) U.S. Cl. 369/112.05

(57) ABSTRACT

The present invention provides a construction that can obtain tracking error signals suitably from any of the optical disks having differing track pitch by reducing the main spot size in an optical recording disk apparatus which reads and retrieve information on an optical recording disk. In the optical recording apparatus, diffraction element 8 for 3-beam generation increases the rim intensity of zero-order beam by decreasing the intensity of the zero-order beam in inner diffraction region 81 to decrease the size of the main spot. Additionally, between optical recording disks of the DVD system and the CD system which retrieve and record information on the optical recording disk apparatus, the optical system is configured such that the sub-spot is centered at the location shifted from the center of the main spot in the tracking direction at a distance of 0.25 times the track pitch.

### CROSS-REFERENCE TO RELATED APPLICATION

This application claims priority of Japanese Patent Application No. 2005-312643, filed Oct. 27, 2005, the complete disclosure of which is hereby incorporated by reference.

### BACKGROUND OF THE INVENTION

a) Field of the Invention

The present invention relates to an optical recording disk apparatus that records and/or retrieves information on an optical disk.

b) Description of the Related Technology

The optical recording disk apparatus that records and/or retrieves information on an optical disk has a laser beam source, a photodetector, an optical system constituting an outward path that conducts the laser beam emitted from the laser beam source to the optical disk, and a return path that conducts the returning beam reflected from the optical disk to the photodetector. Further, in the optical recording disk apparatus, in order to obtain tracking error signals by means of the differential push-pull method (hereinafter, termed DPP (Differential Push-Pull) method), a main beam comprising the zero-order beam emitted from the laser beam source and a sub-beam comprising the diffracted beam are generated by the diffraction elements.

For such diffraction elements, technology has been disclosed that uses diffraction elements formed in the groove section in a region smaller than the cross-sectional area of the luminous flux of the light beam (for example, Japanese Patent Application Disclosure (Kokai) H10-162383).

Furthermore, in order to make the spot size of the beam on the optical disk small enough, diffraction elements have been proposed wherein the groove width is nearly half the length of the lattice period near the center region, while the lattice groove width is wider than half the length of the lattice period near the outer perimeter section (for example, Japanese Patent Application Disclosure (Kokai) 2004-295954).

### PROBLEMS ADDRESS BY THE INVENTION

Whichever of these diffraction elements is used, because the luminous intensity of the zero-order beam can be reduced in the center region of the luminous flux of the laser, the luminous intensity distribution can be equalized after passage through the diffraction elements, in comparison to before the passage. For this reason, the main spot size can be made small, and on the other hand, the spot size increases for the sub-spot. Consequently, the sub-spot is generated to span a plurality of tracks; therefore, the tracking error signals can be obtained suitably by the DPP method, no matter where the sub-spot location is in the tracking direction.

However, in the optical recording disk apparatus, when, for example, the information is recorded and/or retrieved on a plural variety of optical disks having differing pitch, tracking error signals can be obtained suitably by the DPP method for the reasons mentioned above, when the optical disk has a narrow track pitch, but in the case of an optical disk having a wide track pitch, the sub-beam is sometimes not formed to span a plurality of tracks; under such conditions, when attempts are made to generate tracking error signals by the DPP method, the appropriate sub-push-pull signals (hereinafter, SPP signals) are not obtained; there are situations where the tracking error signals cannot be obtained with precision.

In particular, in the optical recording disk apparatus, when, for example, the information is recorded and/or retrieved on a plural variety of optical disks having differing pitch, i.e. on optical disks of the CD (Compact Disc) system and the optical disks of the DVD (Digital Versatile Disc) system, the first laser beam source that emits laser beam having first wavelength for CD use, and the second laser beam source that emits laser beam having second wavelength for DVD use are used as laser beam sources. Then, when the outward path and the return path are in common use by the first laser beam and the second laser beam, the aperture ratio is small for the first laser beam so the main spot size cannot be made as small for the first laser beam; for the sub-spot, the spot size cannot be made that large. Moreover, the CD system optical disk has a wider track pitch in comparison to the DVD system optical disk. As a result, the tracking error signals can be obtained suitably by the DPP method for the DVD system optical disk having narrow track pitch; but in the case of the CD system optical disk having wide track pitch, the sub-spot is not formed to span a plurality of tracks; moreover, depending on its location, appropriate SPP signals are not obtained when attempts are made to generate tracking error signals by the DPP method; thus the tracking error signals cannot be obtained with precision.

### OBJECT AND SUMMARY OF THE INVENTION

In view of the above problem items, the primary object of the present invention is to provide a construction that can obtain tracking error signals suitably by reducing the main spot size by equalizing the luminous intensity distribution of the laser beam by the diffraction elements for 3-beam generation, in the optical recording disk apparatus that records and/or retrieves information on the optical disk.

Furthermore, the object of the present invention is also to provide a construction that can, moreover, obtain tracking error signals suitably from any of the optical disks having differing track pitch, by reducing the main spot size by equalizing the luminous intensity distribution of the laser beam by means of the diffraction elements for 3-beam generation, in the optical recording disk apparatus that records and/or retrieves information on a plural variety of optical disks having differing track pitch.

To solve the aforementioned problems, the present invention is characterized by the fact that it records and/or retrieves information on first optical disk and second optical disk having differing track pitch, wherein the apparatus has a laser beam source, and a photodetector, and an optical system constituting an outward path that conducts the laser beam emitted from the laser beam source to the optical disk, and a return path that conducts the returning beam reflected from this optical disk to the photodetector, and a tracking error signal generation circuit that generates tracking error signals by the differential push-pull method, based on the detection results from the above photodetector; this optical system contains diffraction elements for 3-beam generation, provided with an inner diffraction region containing at the least, the center section of the incident region, and an outer region with zero-order beam transmittance higher than that of the inner diffraction region, in the incident region for the laser beam emitted from the laser beam source, at a location along the outward path; the 3-beam member generated by the diffraction elements forms the sub-spot centered at the location shifted in the tracking direction from the center of the main spot, at the distance of 0.2 to 0.8 times the track pitch of the first optical disk that has the larger amplitude [on comparison] of the first optical disk and the second optical disk, for the sub-push pull signals (SPP signals) used in the differential push-pull method (DPP method).

Diffraction elements to which the present invention is applied are provided in the laser beam incident region with an inner diffraction region containing at the least the center section of the incident region, and a high transmittance region having zero-order beam transmittance higher than that of the inner diffraction region; therefore, when the main beam comprising the zero-order beam and the sub-beam comprising the diffracted beam are formed, the intensity distribution of the zero-order beam has the shape wherein the base of the peak shape is lifted up relative to the lowering of the center region to the extent of the diffraction of the center of the luminous flux of the laser beam. Consequently, the zero-order beam incident to the objective can have the same effects as when NA is enlarged; therefore, when the main beam is made to converge on the track of the optical disk, the spot size can be made small. Further, because the sub-spot size is enlarged, the sub-spot is formed to span a plurality of tracks; therefore, the tracking error signals can be obtained suitably by the DPP method, no matter where the sub-spot is located in the tracking direction.

However, when the information is recorded and/or retrieved on the first optical disk and the second optical disk having differing track pitch, when the locations, etc. of the optical elements are optimized for one of the optical disks, the locations of the sub-spots formed on the other optical disk become unsuitable. Therefore, in the present invention, because the relative locations of the main spot and the sub-spot are prescribed with the first optical disk that has the large amplitude for the SPP signals used in the DPP method as the standard, the tracking error signals can be generated with precision for either the first optical disk or the second optical disk.

Further, the present invention has the following construction when it is prescribed from the standpoint of the track pitch. In other words, the present invention is characterized as comprising the optical recording disk apparatus that records and/or retrieves information on a first optical disk and a second optical disk having differing track pitch, wherein the apparatus has a laser beam source, and a photodetector, and an optical system constituting an outward path that conducts the laser beam emitted from the laser beam source to the optical disk, and a return path that conducts the returning beam reflected from this optical disk to the photodetector, and a tracking error signal generation circuit that generates tracking error signals by the differential push-pull method, based on the detection results from the above photodetector; this optical system contains diffraction elements for 3-beam generation, provided with an inner diffraction region containing at the least, the center section of the incident region, and an outer region with zero-order beam transmittance higher than that of the inner diffraction region, in the incident region for the laser beam emitted from the laser beam source, at a location along the outward path; the 3-beam member generated by the diffraction elements generates a sub-spot centered at the location shifted in the tracking direction from the center of the main spot, at the distance of 0.2 to 0.8 times the track pitch of the first optical disk that has the wider track pitch of the two, in comparison, of the first optical disk and the second optical disk.

Diffraction elements to which the present invention is applied are provided in the laser beam incident region with an inner diffraction region containing at the least the center section of the incident region, and a high transmittance region having zero-order beam transmittance higher than that of the inner diffraction region; therefore, when the main beam comprising the zero-order beam and the sub-beam comprising the diffracted beam are formed, the intensity distribution of the zero-order beam has the shape wherein the base of the peak shape is lifted up relative to the lowering of the center region to the extent of the diffraction of the center of the luminous flux of the laser beam. Consequently, the zero-order beam incident to the objective can have the same effects as when NA is enlarged; therefore, when the main beam is made to converge on the track of the optical disk, the spot size can be made small. Further, because the sub-spot size is enlarged, the sub-spot is formed to span a plurality of tracks; therefore, the tracking error signals can be obtained suitably by the DPP method, no matter where the sub-spot is located in the tracking direction.

However, when the information is recorded and/or retrieved on the first optical disk and the second optical disk having differing track pitch, when the locations, etc. of the optical elements are optimized for one of the optical disks, the locations of the sub-spots formed on the other optical disk become unsuitable. Therefore, in the present invention, because the relative locations of the main spot and the sub-spot are prescribed with the first optical disk that has the large track pitch as the standard, the tracking error signals can be generated with precision for either the first optical disk or the second optical disk.

Further, in the present invention, the distance of 0.2 to 0.8 times the track pitch of the first optical disk is meant to include constructions optically equivalent thereto. In other words, the meaning also includes the constructions wherein the distance constitutes integral multiples of the track pitch of the first optical disk added to the distance of 0.2 to 0.8 times the track pitch of the first optical disk; for example, the distance of 1.2 to 1.8 times, and the distance of 2.2 to 2.8 times the track pitch of the first optical disk.

In the present invention, the 3-beam member generated by these diffraction elements preferably forms the sub-spot centered at the location shifted in the tracking direction from the center of the main spot, at the distance of 0.5 times the track pitch of the first optical disk.

In the present invention, the 3-beam member generated by these diffraction elements preferably forms the sub-spot centered at the location shifted in the tracking direction from the center of the main spot, at the distance of 0.25 or 0.75 times the track pitch of the first optical disk

In the present invention, when all the optical disks having differing track pitch comprise DVD systems, even with the same DVD systems, the track pitch is 1.30 μm (land 0.615 μm +groove 0.615 μm) for the DVD-RAM (Digital Versatile Disk Random Access Memory), the track pitch is 0.74 μm for the DVD±R (Digital Versatile Disk Recordable); the track pitch differs for the DVD-RAM and the DVD±R. Consequently, in the case of the DVD system disks, the relative locations of the main spot and the sub-spot are prescribed with the DVD-RAM that has the larger track pitch as the standard.

In the present invention, it is also feasible to have as the first optical disk, a CD system disk, for example, and as the second optical disk, a DVD system disk, for example. In this case, the laser beam source is provided with a first laser beam source that emits the first wavelength laser beam for CD use and a second laser beam source that emits the second wavelength laser beam for DVD use. This optical system utilizes the construction wherein the outward path and the return path are constructed for common use by the first laser beam and the second laser beam.

In the present invention, the diffraction elements can utilize the construction wherein the outer region comprises a non-diffraction region. In this case, the duty ratio is 50:50 in the inner diffraction region for the plurality of groove sections constituting the diffraction grating and the land sections located between the plurality of grooves; moreover, the center locations in the depth direction for the plurality of grooves constituting the diffraction grating in the inner diffraction region are preferably located at the same height as the surface of the non-diffraction region. Moreover, in the present invention, the diffraction elements can utilize the construction wherein the outer region comprises the outer diffraction region that has diffraction efficiency lower than that of the inner diffraction region. In this case, the duty ratio is 50:50 for the plurality of groove sections constituting the diffraction grating in the inner diffraction region and the outer diffraction region, and the land sections located between the plurality of grooves. Moreover, the center locations in the depth direction for the plurality of groove sections constituting the diffraction grating in the inner diffraction region are preferably located at the same height as the center locations in the depth direction for the plurality of groove sections constituting the diffraction grating in the outer diffraction region. In either of these constructions, the occurrence of astigmatism due to the diffraction region can be prevented; moreover, the first order diffraction efficiency can be made higher than the diffraction efficiencies for the higher orders such as the 3rd order diffraction beam, the 5th order diffraction beam, and the 7th order diffraction beam. In other words, in the case of the diffraction elements described in Patent Reference 1, the occurrence of aberration cannot be prevented, because of the occurrence of large differences in the main beam phase between the regions provided with grooves and the flat sections where grooves are not formed. Furthermore, in the case of the diffraction elements described in Japanese Reference 2004-295954, because the duty ratio of the grating has been changed, the regions that have shifted from the duty ratio of 50:50 have high diffraction efficiencies for the higher orders, such as the 3rd order diffraction beam, the 5th order diffraction beam, and the 7th order diffraction beam. As the result, when the utilization efficiency of the laser beam is increased even slightly, as in the case of the optical recording disk apparatus for recording, there are problems with the occurrence of opposite effects. Nonetheless, the present invention avoids such problems.

Further, the present invention is characterized as comprising the optical recording disk apparatus that records and/or retrieves information on the optical disk, wherein the apparatus has a laser beam source, a photodetector, an optical system constituting an outward path that conducts the laser beam emitted from the laser beam source to the optical disk, a return path that conducts the returning beam reflected from this optical disk to the photodetector, and a tracking error signal generation circuit that generates tracking error signals by the differential push-pull method, based on the detection results from the above photodetector; this optical system contains diffraction elements for 3-beam generation, provided with an inner diffraction region containing at the least, the center section of the incident region, and an outer region with zero-order beam transmittance higher than that of the inner diffraction region, at a location along the outward path in the incident region for the laser beam emitted from the laser beam source; the 3-beam member generated by these diffraction elements forms the sub-spot centered at the location whereto the amplitude of the sub-push-pull signals used in the differential push-pull method has been shifted, at the distance of 0.2 to 0.8 times the track pitch from the center of the main spot in the tracking direction.

Diffraction elements to which the present invention is applied are provided in the laser beam incident region with an inner diffraction region containing at the least the center section of the incident region, and a high transmittance region having zero-order beam transmittance higher than that of the inner diffraction region; therefore, when the main beam comprising the zero-order beam and the sub-beam comprising the diffracted beam are formed, the intensity distribution of the zero-order beam has the shape wherein the base of the peak shape is lifted up relative to the lowering of the center region to the extent of the diffraction of the center of the luminous flux of the laser beam. Consequently, the zero-order beam incident to the objective can have the same effects as when NA is enlarged; therefore, when the main beam is made to converge on the track of the optical disk, the spot size can be made small. Further, because the sub-spot size is enlarged, the sub-spot is formed to span a plurality of tracks; therefore, the tracking error signals can be obtained suitably by the DPP method, no matter where the sub-spot is located in the tracking direction.

### EFFECT OF THE INVENTION

In the present invention, because the diffraction elements are provided in the incident region of the laser beam with an inner diffraction region containing at the least the center section of the incident region, and a high transmittance region having zero-order beam transmittance higher than that of the inner diffraction region, the intensity distribution of the zero-order beam has the shape wherein the base of the peak shape is lifted up relatively; the zero-order beam incident to the objective can have the same effects as when NA is enlarged. Therefore, when the main beam is made to converge on the track of the optical disk, the spot size can be made small.

Further, in the present invention, when the information is recorded and/or retrieved on the first optical disk and the second optical disk having differing track pitch, when the locations, etc. of the optical elements are optimized for one of the optical disks, the locations of the sub-spots formed on the other optical disk become unsuitable. However, in the present invention, because the relative locations of the main spot and the sub-spot are prescribed with the first optical disk wherein such problems occur readily, as the standard, the tracking error signals can be generated with precision for either the first optical disk or the second optical disk.

### BRIEF DESCRIPTION OF THE DRAWINGS

In the drawings:

FIG. 1 comprises the explanatory diagram showing the typical construction of the essential sections of the optical recording disk apparatus relating to the mode of Embodiment 1 of the present invention;

FIG. 2(a), (b), and (c) comprise respectively, the plane view of the diffraction elements used in the present invention, the perspective view of the diffraction grating formed on these diffraction elements, and the cross-sectional view wherein the diffraction elements have been cut along the lengthwise direction of the groove section;

FIG. 3 comprises the explanatory diagram that shows the change in the luminous intensity distribution of the zero-order beam before and after the transmission through the diffraction elements used in the present invention;

FIG. 4(a), (b) comprise respectively, the explanatory diagram showing the mode of formation of the spot on the optical disk in the conventional optical recording disk apparatus, and the explanatory diagram showing the mode of formation of the spot on the optical disk in the optical recording disk apparatus whereto the present invention is applied;

FIG. 5 comprises the explanatory diagram for the DPP method;

FIG. 6(a), (b) comprise respectively, the explanatory diagram showing the mode wherein the spots are formed on the DVD system optical disk when the center of the main spot and the center of the sub-spot are shifted at the distance of 0.5 times the CD track pitch; and the explanatory diagram showing the mode wherein the spots are formed on the CD system optical disk, in the optical recording disk apparatus relating to the Embodiment 1 of the present invention;

FIG. 7(a), (b) comprise respectively, the figures showing the waveform plots of the MPP signals, EPP signals, FPP signals, SPP signals, DPP signals, obtained from the DVD system optical disk and the CD system optical disk, when the center of the main spot and the center of the sub-spot are shifted at the distance of 0.5 times the CD track pitch, in the optical recording disk apparatus relating to the Embodiment 1 of the present invention;

FIG. 8(a), (b) comprise respectively, the explanatory diagram showing the mode wherein the spots are formed on the DVD system optical disk when the center of the main spot and the center of the sub-spot are shifted at a distance of 0.25 times the CD track pitch; and the explanatory diagram showing the mode wherein the spots are formed on the CD system optical recording disk, in the optical recording disk apparatus relating to the mode of Embodiment 1 of the present invention;

FIG. 9(a), (b) comprise respectively, the figures showing the waveform plots for the MPP signals, EPP signals, FPP signals, SPP signals, DPP signals, obtained in the construction associated with the mode of Embodiment 1 of the present invention is utilized in the optical recording disk apparatus wherein the sub-spots are centered at the locations shifted from the center of the main spot at the distance of 0.25 times the track pitch of the CD [system optical disk];

FIG. 10 comprises the waveform plots for the MPP signals, EPP signals, FPP signals, SPP signals, DPP signals, obtained from the CD system optical disk, when the main spot and the sub-spot are centered at the locations shifted at the distance of 0.75 times the CD track pitch, in the optical recording disk apparatus relating to the mode of Embodiment 1 of the present invention;

FIG. 11(a), (b) comprise respectively, the waveform plots for the MPP signals, EPP signals, FPP signals, SPP signals, DPP signals, obtained from the CD system optical disk, when the main spot and the sub-spot are centered at the locations shifted in the tracking direction from the center of the main spot, at the distance of zero to one times the CD track pitch, in the optical recording disk apparatus relating to the Reference Example of the present invention;

FIG. 12(a), (b) comprise respectively, the plane view of the diffraction elements used in the optical disk relating to the mode of Embodiment 2 of the present invention, and the cross-sectional view when the diffraction elements are cut along the lengthwise direction of the groove section;

FIG. 13(a), (b) comprise respectively, the plane view of the diffraction elements used in the optical disk relating to the mode of Embodiment 3 of the present invention, and the cross-sectional view when the diffraction elements are cut along the lengthwise direction of the groove section; and

FIG. 14 comprises the explanatory diagram showing the typical construction of the essential sections of the optical recording disk apparatus relating to the mode of Embodiment 5 of the present invention.

### DESCRIPTION OF THE PREFERRED EMBODIMENTS

Embodiment 1

Overall Description

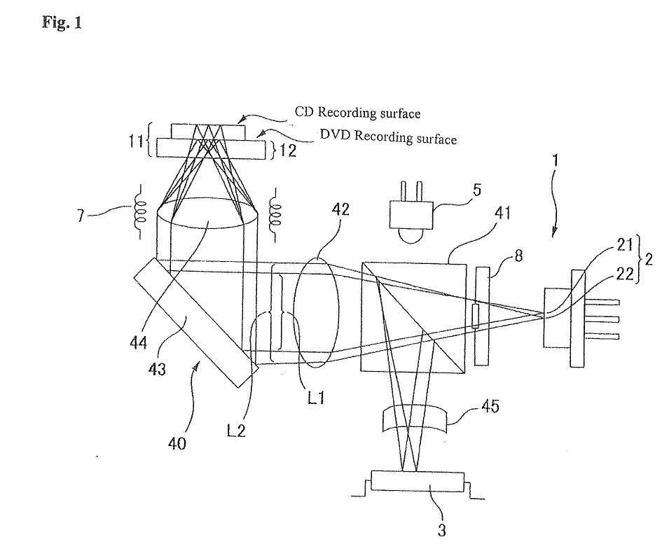

FIG. 1 comprises the explanatory diagram showing the typical construction of the essential sections of the optical recording disk apparatus relating to the Embodiment 1 of the present invention. In FIG. 1, in this embodiment of optical recording disk apparatus 1, the optical recording disk apparatus records and/or retrieves information on the CD system optical disk 11 (first optical disk), and the DVD system optical disk 12 (second optical disk), that have differing track pitch and differing thickness of the protective layer covering the recording surface. Laser beam source 2 is used, comprising a 2-wavelength semiconductor laser, wherein the first semiconductor laser 21, emitting the first laser beam L1 having wavelength of 740 nm for CD use, and the second semiconductor laser 22, emitting the second laser beam L2 having wavelength of 650 nm for DVD use, constitute the entity. Further, in the optical recording disk apparatus 1, a common-use photodetector 3 is used, that receives the returning beam from both the first laser beam L1 and the second laser beam L2. Furthermore, the optical recording disk apparatus 1 has a common-use optical system 40, provided with a beam splitter 41, collimating lens 42, vertical tilt mirror 43, and objective 44, in that order, from the laser beam source 2 toward the optical disks 11, 12. The outward path conducting the laser beams L1, L2 emitted from the laser beam source 2 to the optical disks 11, 12 constitutes these optical elements. Furthermore, the optical system 40 is provided with a sensor lens 45 for astigmatism generation, between the beam splitter 41 and the photodetector 3; the return path that conducts the returning beam reflected from the optical disks 11, 12 to the photodetector 3 constitutes the objective 44, the vertical tilt mirror 43, the collimating lens 42, the beam splitter 41, and the sensor lens 45. Further, as seen from the position of the photodetector 3, a front monitor 5 (beam detector for monitoring) is located behind the beam splitter 41 to detect the beam reflected by the beam splitter 41, in the laser beam sent from the laser beam source 2 to the optical disks 11, 12.

Photodetector 3 is used to generate focusing error signals and tracking error signals, when the information is recorded by detecting the returning beam reflected from the optical disks 11, 12, or when the information is retrieved; these focusing error signals and tracking error signals undergo feedback to the objective drive apparatus 7.

In the optical recording disk apparatus 1 of this embodiment, the diffraction elements 8 are provided between the laser beam source 2 and the beam splitter 41, to generate the sub-beam comprising the negative first order diffraction beam, the main beam comprising the zero-order beam, and the sub-beam comprising the positive first order diffraction beam, from the laser beam emitted from the laser beam source 2. Therefore, information can be retrieved by converging the main beam comprising the zero-order beam on the optical disks 11, 12 by means of the objective 44, and detecting the returning beam therefrom with the photodetector 3. Further, information can be recorded by converging the main beam comprising the zero-order beam on the optical disks 11, 12, by means of the objective 44. Furthermore, when the sub-beam comprising the negative first order diffraction beam and the sub-beam comprising the positive first order diffraction beam are made to converge by means of the objective 44 at the location where the main beam spot is sandwiched in the tangential direction of the track for optical disks 11, 12, and the returning beam is detected by the photodetector 3, tracking error signals can be obtained by the DPP method.

Construction of the Diffraction Elements 8

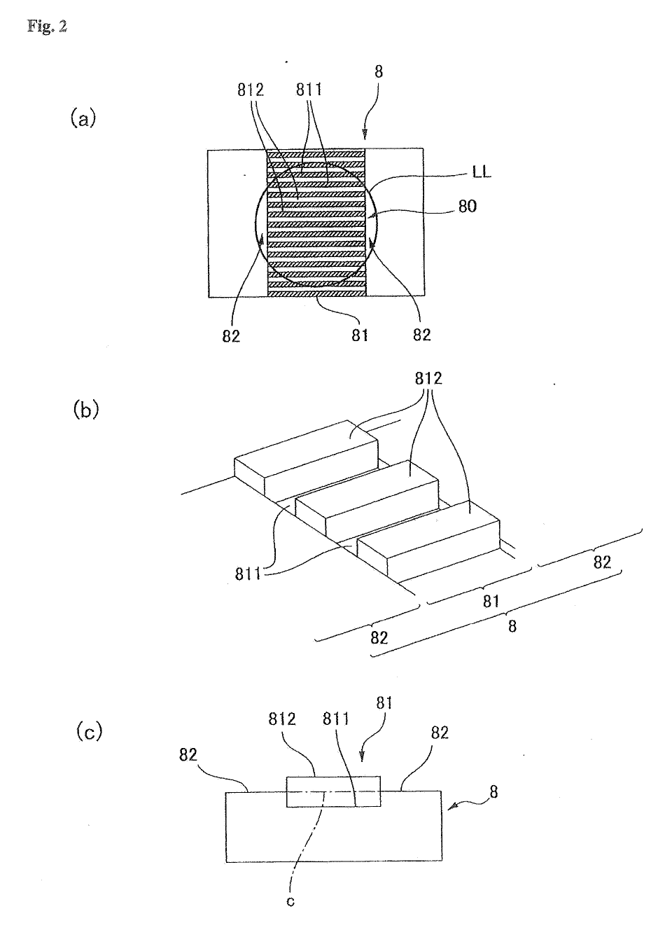

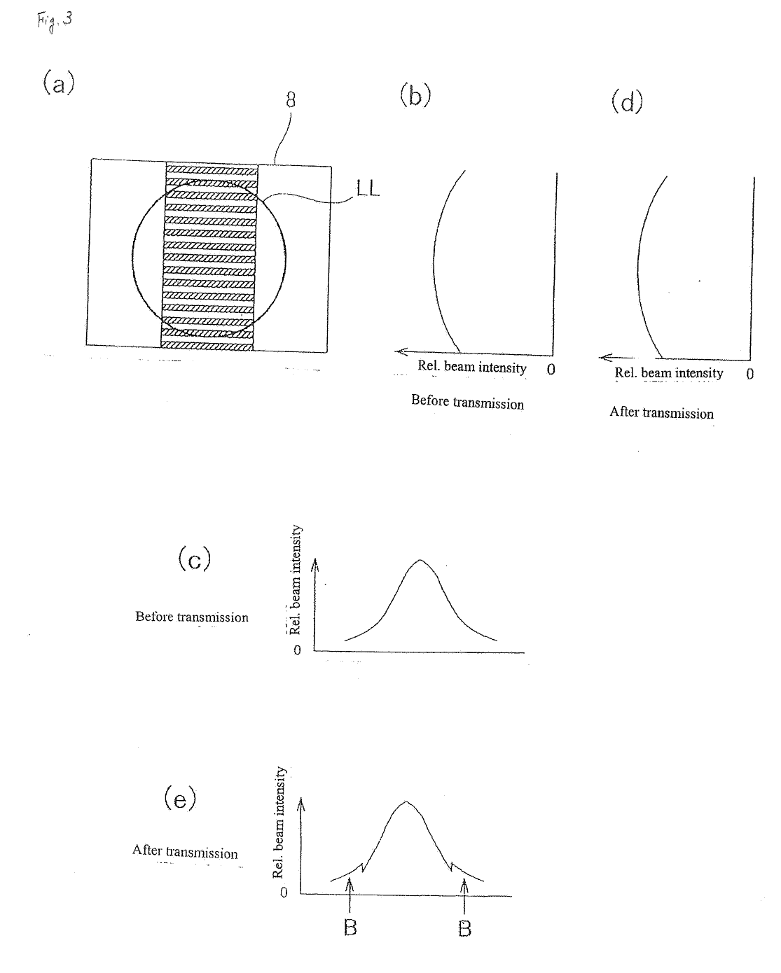

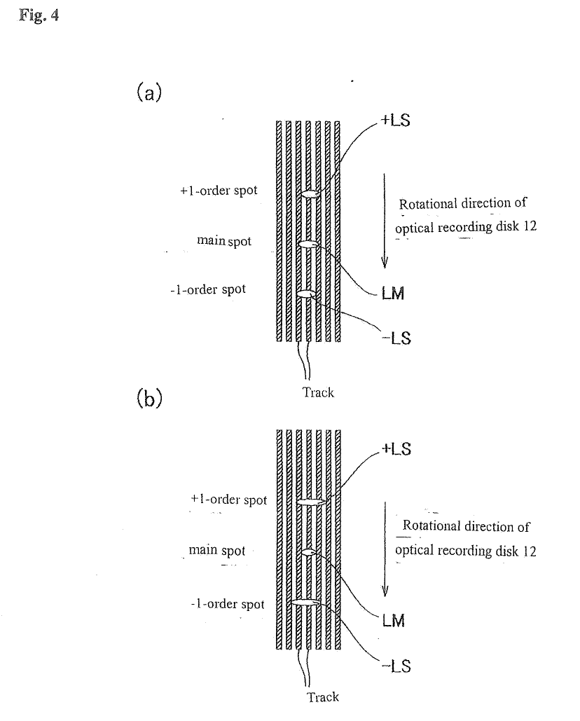

FIG. 2(a), (b), (c) comprise respectively, the plane view of the diffraction elements used in the present invention, the perspective view of the diffraction grating formed on these diffraction elements, and the cross-sectional view wherein the diffraction elements have been cut along the lengthwise direction of the groove section. FIG. 3 comprises the explanatory diagram that shows the change in the luminous intensity distribution of the zero-order beam before and after its transmission through the diffraction elements. Together with showing the plane view of the diffraction elements 8 in FIG. 3(a), and together with showing in FIG. 3(b), (c), the luminous intensity distribution of the incident beam to these diffraction elements 8 (before transmission through the diffraction elements 8), in correspondence to the direction of the diffraction elements 8 in FIG. 3(a), the luminous intensity distribution of the emitted beam from the diffraction elements 8 (after transmission through the diffraction elements 8) is shown in FIG. 3(d), (e), in correspondence to the direction of the diffraction elements 8 in FIG. 3(a). FIG. 4(a), (b) comprise respectively, the explanatory diagram showing the mode of formation of the spot on the optical disk in the conventional optical recording disk apparatus, and the explanatory diagram showing the mode of formation of the spot on the optical disk in the optical recording disk apparatus whereto the present invention is applied.

As shown in FIG. 2(a), (b), (c), in the optical recording disk apparatus 1 of this embodiment, the diffraction elements 8 are provided with a band-shaped inner diffraction region 81 containing at the least, the center section of the incident region, and the outer region 82 with zero-order beam transmittance higher than that of the inner diffraction region 81, in the incident region 80 for laser beams L1, L2 emitted from the laser beam source 2; in this embodiment, the outer region 82 comprises a non-diffraction region provided with no diffraction grating. Here, the plurality of groove sections 811 constituting the diffraction grating in the inner diffraction region 81, and the land sections 812 located between these groove sections 811 have the same width; the duty ratio is 50:50 for the groove sections 811 and the land sections 812. Further, the center location (shown by dotted line C) in the depth direction for the plurality of groove sections 811 constituting the diffraction grating in the inner diffraction region 81 is at a location identical in height to the surface of the outer region 82 (non-diffraction region).

Further, the far field pattern of the laser beam emitted from the laser beam source 2 is elliptical; its major axis direction corresponds to the direction orthogonal to the lengthwise direction of the groove sections 811; the minor axis direction corresponds to the lengthwise direction of the groove sections 811. Furthermore, the laser beam emitted from the laser beam source 2 is utilized in the convergence on the region shown by the circle LL in FIG. 2(a) in the optical disks 11, 12.

As shown in FIG. 3(a), (b), (d), in the optical recording disk apparatus 1 of this embodiment, the distribution of the quantity of light, when the diffraction elements are cut in the direction wherein the luminous flux of the laser is orthogonal to the groove section 811 of the diffraction elements 8, does not change greatly from before to after the transmission through the diffraction elements 8. In contrast to this, as shown in FIG. 3(a), (c), (e), the distribution of the quantity of light, when the diffraction elements are cut in the direction wherein the luminous flux of the laser is parallel to the groove section 811 of the diffraction elements 8, changes greatly from before to after the transmission through the diffraction elements 8. In other words, in contrast to the large reduction in the luminous intensity of the zero-order beam emitted from the inner diffraction region 811 of the diffraction elements 8, the luminous intensity of the zero-order beam emitted from the outer diffraction region 82 is not reduced. Consequently, the peak shape of the zero-order beam, when the quantity of light is greatly reduced in the center region, has the shape wherein the base of the peak shape is lifted up, as shown by the arrow B in FIG. 3(c); the rim intensity is increased. Consequently, it is possible to obtain effects identical to those from enlarging NA, for the zero-order beam incident to the objective 44.

Therefore, when the laser beams L1, L2 are made to converge on the optical disks 11, 12, as shown in the conventional example in FIG. 4(a), and in the application example of the present invention in FIG. 4(b), the spot size can be made small for the main spot LM from the convergence on the optical disks 11, 12, according to the Embodiment of the present invention. Therefore, because the laser beam emitted from the laser beam source 2 can record on the optical disks 11, 12, even at low power, it is possible to devise power conservation and cost reduction; moreover, countermeasures to heat generation become simple.

Further, according to this embodiment, on comparison with conventional examples, the spot size is enlarged for both the positive first order sub-spot +LS and the negative first order sub-spot −LS. Consequently, there is a wide tolerance in the precision of the location of the track and the sub-spot, and an increase in the operational efficiency can be devised when the optical recording disk apparatus 1 is manufactured.

Furthermore, in this embodiment, the center location (shown by the dot-dash line C in FIG. 2(c)) in the depth direction of the groove sections 811 is at the same height in the lengthwise direction of the groove sections 811; moreover, the center location in the depth direction of the groove sections 811 is at the same height as the surface of the outer region 82; therefore, there is the advantage that astigmatism does not occur. Moreover, the duty ratio of the grating in the diffraction elements 8 is always 50:50; therefore, the occurrence of higher order diffraction beams, in particular, can be suppressed.

Generation of Tracking Error Signals by the DPP Method

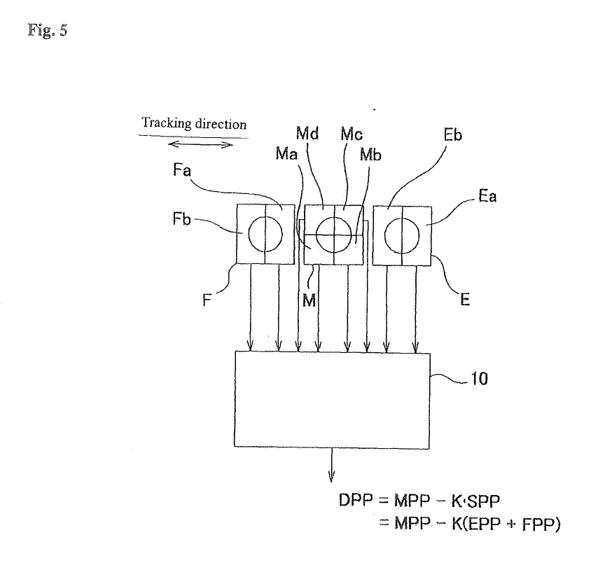

FIG. 5 comprises the explanatory diagram for the DPP method. When the tracking error signals are generated by the DPP method in the optical recording disk apparatus 1 in this embodiment, as shown in FIG. 5, the light-receiving surface in photodetector 3 constitutes the main light-receiving region M that receives light comprising the returning beam of the main spot, and the 2 sub-light-receiving regions E, F, one on each side, that receive light comprising the returning beam of the sub-spot; the 2 sub-light-receiving regions E, F are split in 2 in the direction corresponding to the tracking direction of the optical disk. Furthermore, the main light-receiving region M is split in 4 in the direction corresponding to the tracking direction of the optical disk and in the direction orthogonal thereto. Here, when the amount of light received in the main light-receiving region M and in the sub-light-receiving regions E, F constitutes Ma˜Md, Ea, Eb, Fa, Fb, the tracking error signal generation circuit 10 obtains the main push-pull (MPP) and the sub-push-pull (SPP) by performing the following operations on the detection results in the respective light-receiving regions; by performing the operations thereon using the prescribed constant K, the differential push-pull is obtained:
MPP=(Mb+Mc)−(Ma +Md)
EPP=Ea−Eb
FPP=Fa−Fb
SPP=EPP+FPP
DPP=MPP−KSPP
=((Mb+Mc)−(Ma+Md))−K·((Ea−Eb)+(Fa−Fb))

this differential push-pull DPP comprises the tracking error signals.

### SETUP EXAMPLE 1 FOR LOCATING THE SUB-SPOTS

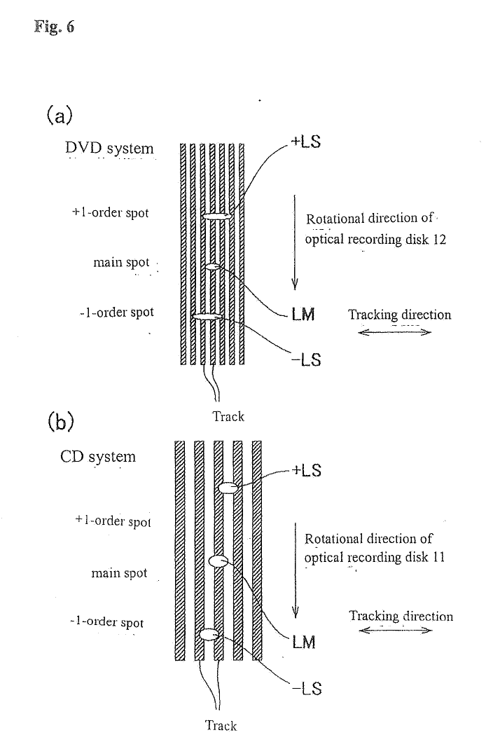

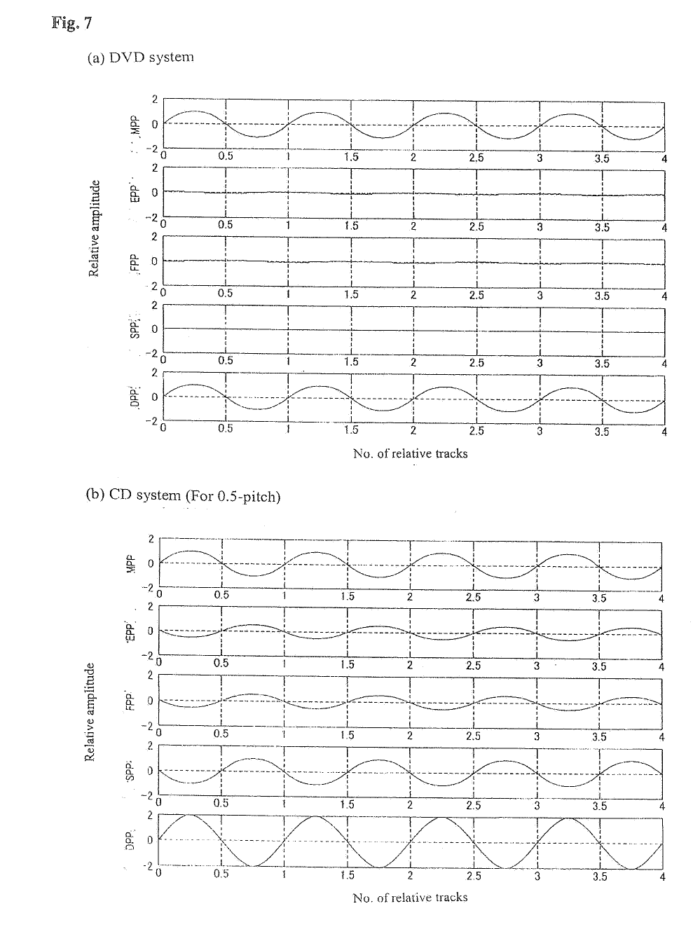

FIG. 6(a), (b) comprise respectively, the explanatory diagram showing the mode wherein the spots are formed on the DVD system optical disk 11, and the explanatory diagram showing the mode wherein the spots are formed on the CD system optical disk 12, in the optical recording disk apparatus of this embodiment. FIG. 7(a), (b) comprise respectively, the figures showing the waveform plots for the MPP signals, EPP signals, FPP signals, SPP signals, DPP signals, obtained when the construction shown in FIG. 6(a), (b) is utilized in the optical recording disk apparatus of this embodiment. Furthermore, this example, in the CD system optical disk 11 and the DVD system optical disk 12, corresponds to the example wherein the sub-spots are centered at the locations shifted in the tracking direction from the center of the main spot, at the distance of 0.5 times the track pitch of the CD system optical disk 11 that has the larger amplitude for the sub-push-pull signals used in the differential push-pull method; for example, in the CD system optical disk 11 and the DVD system optical disk 12, [corresponds] to the example wherein the sub-spots are centered at the locations shifted in the tracking direction from the center of the main spot, at the distance of 0.5 times the track pitch of the CD system optical disk 11 that has the wide track pitch.

In the optical recording disk apparatus 1 in this embodiment, as shown in FIG. 6(a), when the size of the main spot LM is small, the sizes of the sub-spots +LS, −LS are enlarged thereby. Consequently, in the DVD system optical disk 12, the sub-spots +LS, −LS are formed to span a plurality of tracks; thus the tracking error signals can be obtained suitably by the DPP method, no matter where the sub-spots +LS, −LS are located in the tracking direction. However, as shown in FIG. 6(b), in the CD system optical disk 11, the NA value is small, so the size of the main spot LM cannot be made that small; the sizes of the sub-spots +LS, −LS are only slightly larger than the size of the main spot M. Moreover, in the CD system optical disk 11, the track pitch is wider in comparison to the DVD system optical disk 12. Therefore, in the case of the CD system optical disk 11, the sub-beams +LS, −LS are not formed to span a plurality of tracks; moreover, depending on the location, the amplitude of the SPP signals is large when attempts are made to generate the tracking error signals by the DPP method; appropriate DPP signals are not obtained. Furthermore, it can also be said of such a CD system optical disk 11, that it is an optical disk having large amplitude for the SPP signals used in the DPP method, in comparison to the DVD system optical disk 12.

Therefore, in this embodiment, for the locations of the sub-spots +LS, −LS, as shown in FIG. 6(b), the optical system has the construction wherein the sub-spots +LS, −LS are centered at the locations shifted in the tracking direction from the center of the main spot LM, at the distance of 0.5 times the track pitch of the CD system optical disk 11. Consequently, as shown in FIG. 7(a), because the sub-spots +LS, −LS are formed to span a plurality of tracks in the DVD system optical disk 12, the tracking error signals can be obtained suitably by the DPP method, no matter where the sub-spots +LS, −LS are located in the tracking direction. On the other hand, in the CD system optical disk 11, as in the case of the usual DPP method, the sub-spots +LS, −LS are centered at the locations shifted in the tracking direction from the center of the main spot LM, at the distance of 0.5 times the track pitch of the CD system optical disk 11; therefore, the tracking error signals (DPP signals) can be obtained suitably by the DPP method. Furthermore, in this embodiment, the SPP signals have some excess in the amplitude, so these SPP signals can be used for other controls.

### SETUP EXAMPLE 2 FOR LOCATING THE SUB-SPOTS

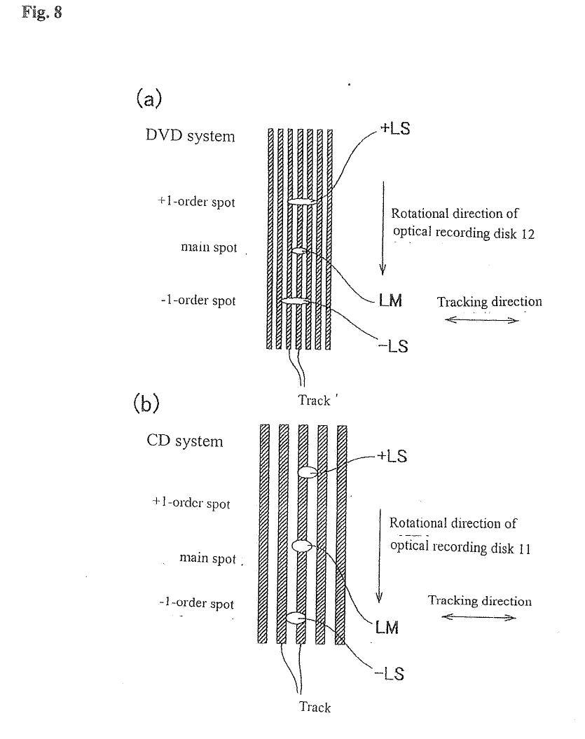

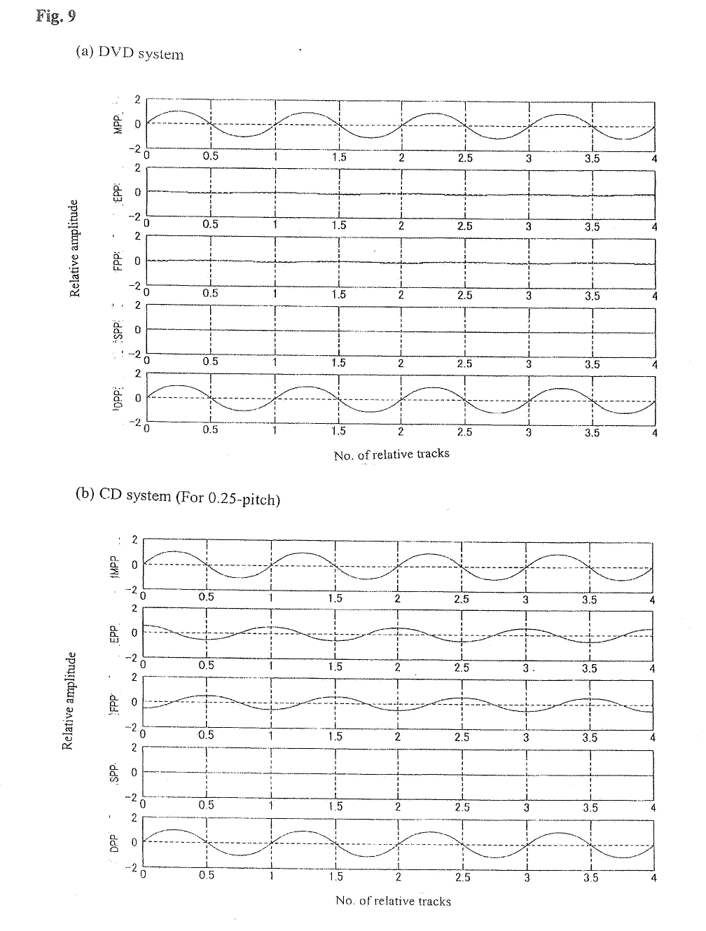

FIG. 8(a), (b) comprise respectively, the explanatory diagram showing the mode wherein the spots are formed on the DVD system optical disk 11 under different conditions in the optical recording disk apparatus, and the explanatory diagram showing the mode wherein the spots are formed on the CD system optical disk 12. FIG. 9(a), (b) comprise respectively, the figures showing the waveform plots for the MPP signals, EPP signals, FPP signals, SPP signals, DPP signals, obtained when the construction shown in FIG. 8(a), (b) is utilized in the optical recording disk apparatus of this embodiment. Furthermore, this example, in the CD system optical disk 11 and the DVD system optical disk 12, corresponds to the example wherein the sub-spots are centered at the locations shifted in the tracking direction from the center of the main spot, at the distance of 0.5 times the track pitch of the CD system optical disk 11 that has the larger amplitude for the sub-push-pull signals used in the differential push-pull method; for example, in the CD system optical disk 11 and the DVD system optical disk 12, [corresponds] to the example wherein the sub-spots are centered at the locations shifted in the tracking direction from the center of the main spot, at the distance of 0.25 times the track pitch of the CD system optical disk 11 that has the wide track pitch.

In the optical recording disk apparatus 1 in this embodiment as well, as shown in FIG. 8(a), when the size of the main spot LM is small, the sizes of the sub-spots +LS, −LS are enlarged thereby; consequently, in the DVD system optical disk 12, the tracking error signals can be obtained suitably by the DPP method, no matter where the sub-spots +LS, −LS are located in the tracking direction. In contrast to this, as shown in FIG. 8(b), in the CD system optical disk 11, the sizes of the sub-spots +LS, −LS can only be made slightly larger than the size of the main spot M; moreover, the track pitch is wider.

Therefore, in this embodiment, for the locations of the sub-spots +LS, −LS, as shown in FIG. 8(b), the optical system has the construction wherein the sub-spots +LS, −LS are centered at the locations shifted in the tracking direction from the center of the main spot LM, at the distance of 0.25 times the track pitch of the CD system optical disk 11. Consequently, as shown in FIG. 9(a), because the sub-spots +LS, −LS are formed to span a plurality of tracks in the DVD system optical disk 12, the tracking error signals can be obtained suitably by the DPP method, no matter where the sub-spots +LS, −LS are located in the tracking direction.

On the other hand, in the CD system optical disk 11, differing from the case of the usual DPP method, the sub-spots +LS, −LS are centered at the locations that are not shifted in the tracking direction from the center of the main spot LM, at the distance of 0.25 times the track pitch of the CD system optical disk 11; therefore, the EPP signals and the FPP signals are in opposite phase, moreover the EPP signals and the FPP signals are not in phase with the MPP signals; but the amplitude of the SPP signals is very small, moreover, stable; therefore, the tracking error signals can be obtained suitably by the DPP method.

### OTHER SETUP EXAMPLES FOR LOCATING THE SUB-SPOTS

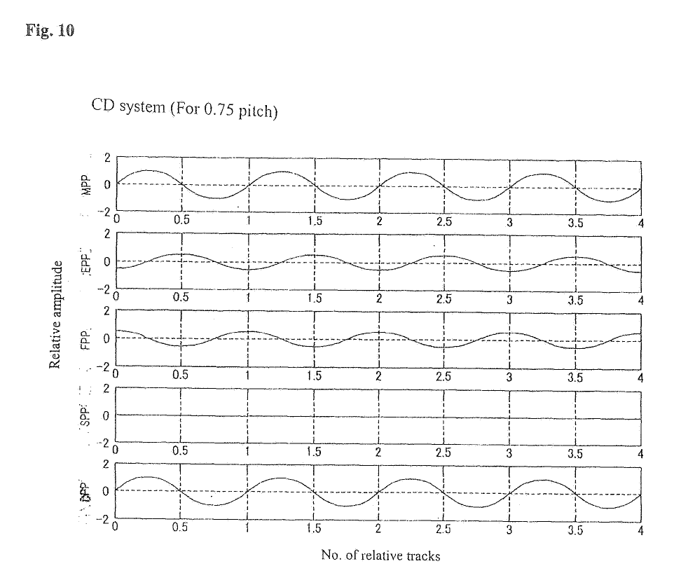

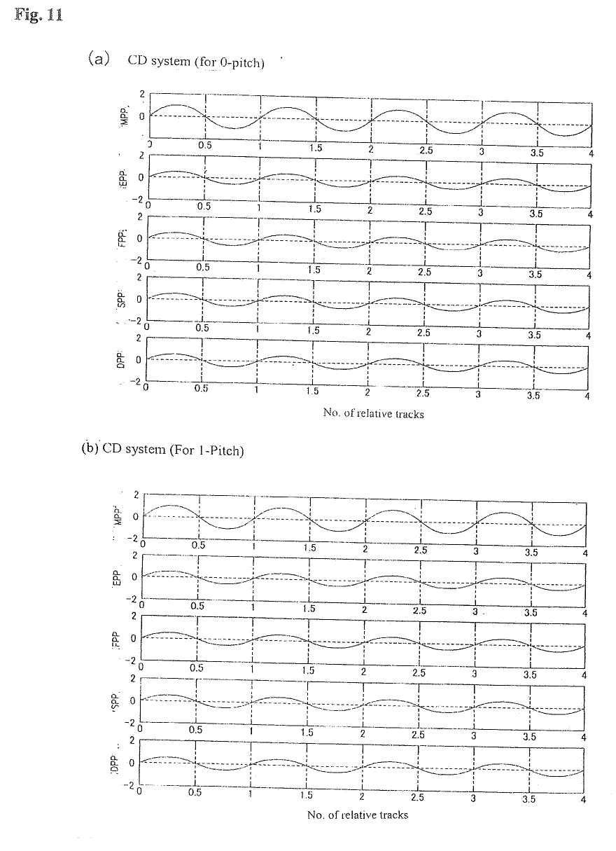

FIG. 10 comprises the waveform plots for the MPP signals, EPP signals, FPP signals, SPP signals, DPP signals, obtained from the CD system optical disk, when the main spot and the sub-spot are centered at the locations shifted in the tracking direction, at the distance of zero to one times the CD track pitch, in the optical recording disk apparatus relating to the Reference Example of the present invention. FIG. 11(a), (b) comprise respectively, the waveform plots for the MPP signals, EPP signals, FPP signals, SPP signals, DPP signals, obtained from the CD system optical disk, when the main spot and the sub-spot are centered at the locations shifted in the tracking direction from the center of the main spot, at the distance of zero to one times the CD track pitch, in the optical recording disk apparatus relating to the Reference Example of the present invention.

In the Setup Examples 1, 2 described above, the center of the main spot and the center of the sub-spots are shifted in the tracking direction at the distance of 0.5 or 0.25 times the track pitch of the CD system optical disk 12; but as shown in FIG. 10, even when the center of the main spot and the center of the sub-spot are shifted in the tracking direction at the distance of 0.75 times the track pitch of the CD system optical disk 12, results almost identical to the Setup Example 2 described above can be obtained.

Here, when the center of the main spot and the center of the sub-spot are shifted in the tracking direction at 0˜0.25 times the track pitch of the CD system optical disk 12, results that are between the results shown in FIG. 9 and the results shown in FIG. 11(a) can be obtained. Further, when the center of the main spot and the center of the sub-spot are shifted in the tracking direction at 0.25˜0.5 times the track pitch of the CD system optical disk 12, results that are between the results shown in FIG. 7 and the results shown in FIG. 9 can be obtained. Furthermore, when the center of the main spot and the center of the sub-spot are shifted in the tracking direction at 0.5˜0.75 times the track pitch of the CD system optical disk 12, results that are between the results shown in FIG. 7 and the results shown in FIG. 10 can be obtained. Moreover, when the center of the main spot and the center of the sub-spot are shifted in the tracking direction at 0.75˜1 times the track pitch of the CD system optical disk 12, results that are between the results shown in FIG. 10 and the results shown in FIG. 11(b) can be obtained. When these results are examined, the preferable range for the amount of shift in the tracking direction for the center of the main spot and the center of the sub-spot comprises 0.2˜0.8 times the track pitch of the CD system optical disk 12.

Embodiment 2

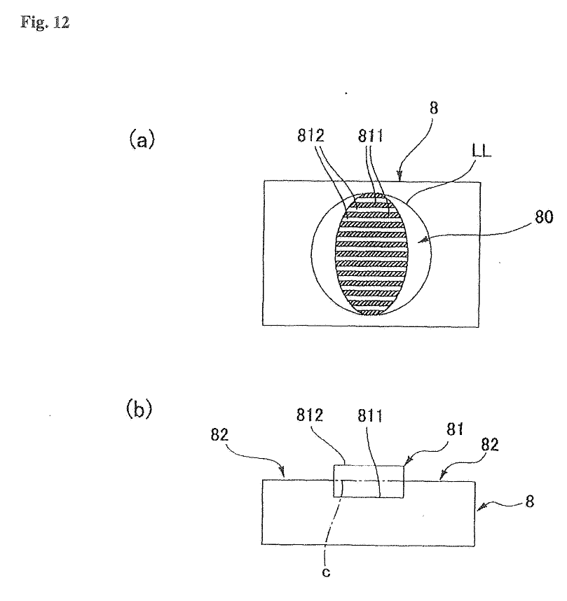

FIG. 12(a), (b) comprise respectively, the plane view of the diffraction elements used in the optical disk relating to the Embodiment 2 of the present invention, and the cross-sectional view when the diffraction elements are cut along the lengthwise direction of the groove section. Further, in this embodiment and in any of the embodiments explained below, the basic construction is identical to Embodiment 1; therefore, the common parts are explained by labeling with the same codes, and omitting the explanations thereto.

In the Embodiment 1, as explained by reference to FIG. 2(a), (b), (c), the band-shaped inner diffraction region 81 is formed in the diffraction elements 8; but in this embodiment, as shown in FIG. 12(a), the inner diffraction region 81, having an elliptical or elongated circular shape containing at the least, the center section of the incident region, is formed in the incident region 80 for the laser beams L1, L2 emitted from the laser beam source 2; the outer diffraction region 82, having zero-order beam transmittance higher than that of the inner diffraction region 81, is formed around this. Also in this embodiment, just as in Embodiment 1, the outer region 82 comprises a non-diffraction region provided with no diffraction grating. Here, the plurality of groove sections 811 constituting the diffraction grating in the inner diffraction region 81, and the land sections 812 located between these groove sections 811 have the same width; the duty ratio is 50:50 for the groove sections 811 and the land sections 812. Further, as shown in FIG. 12(b), the center location (shown by dotted line C) in the depth direction, for the plurality of groove sections 811 constituting the diffraction grating in the inner diffraction region 81, is at the location identical in height to the surface of the outer region 82 (non-diffraction region).

Embodiment 3

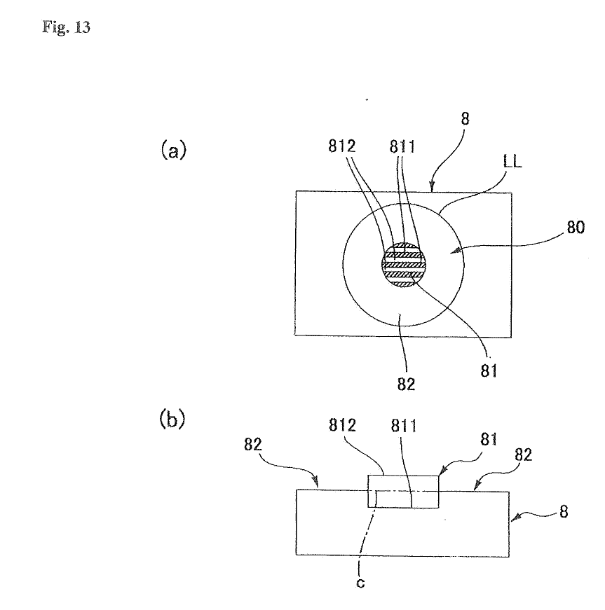

FIG. 13(a), (b) comprise respectively, the plane view of the diffraction elements used in the optical disk relating to the Embodiment 3 of the present invention, and the cross-sectional view when the diffraction elements are cut along the lengthwise direction of the groove section. In Embodiments 1, 2, as explained by reference to FIG. 2(a), (b), (c), and FIG. 12(a), (b), in the diffraction elements 8, the inner diffraction region 81 is formed with a band-shape, an elliptical shape, an elongated circular shape; but in this embodiment, as shown in FIG. 13(a), a circular inner diffraction region 81 is formed, containing at the least, the center section of the incident region, in the incident region 80 for the laser beams L1, L2 emitted from the laser beam source 2; the outer diffraction region 82, having zero-order beam transmittance higher than that of the inner diffraction region 81, is formed around this. Also in this embodiment, just as in Embodiments 1, 2, the outer region 82 comprises a non-diffraction region provided with no diffraction grating. Here, the plurality of groove sections 811 constituting the diffraction grating in the inner diffraction region 81, and the land sections 812 located between these groove sections 811 have the same width; the duty ratio is 50:50 for the groove sections 811 and the land sections 812. Further, as shown in FIG. 13(b), the center location (shown by dotted line C) in the depth direction for the plurality of groove sections 811 constituting the diffraction grating in the inner diffraction region 81 is at the location identical in height to the surface of the outer region 82 (non-diffraction region).

Embodiment 4

Embodiments 1˜3 had the construction wherein a non-diffraction region, provided with no diffraction grating, was formed around the inner diffraction region 81 as the outer region 82 having zero-order beam transmittance higher than that of the inner diffraction region 81; but it is also feasible to have the construction for the outer region 82 wherein the outer diffraction region has diffraction efficiency lower than that of the inner diffraction region 81. In this case, the preferable duty ratio is 50:50 for the plurality of groove sections constituting the diffraction grating in the inner diffraction region 81 and the outer diffraction region 82, and the land sections located between the plurality of grooves; moreover, the preferable center location in the depth direction for the plurality of groove sections 811 constituting the diffraction grating in the inner diffraction region 81 is a location identical in height to the center location in the depth direction for the plurality of groove sections constituting the diffraction grating in the outer diffraction region.

Embodiment 2

Overall Description

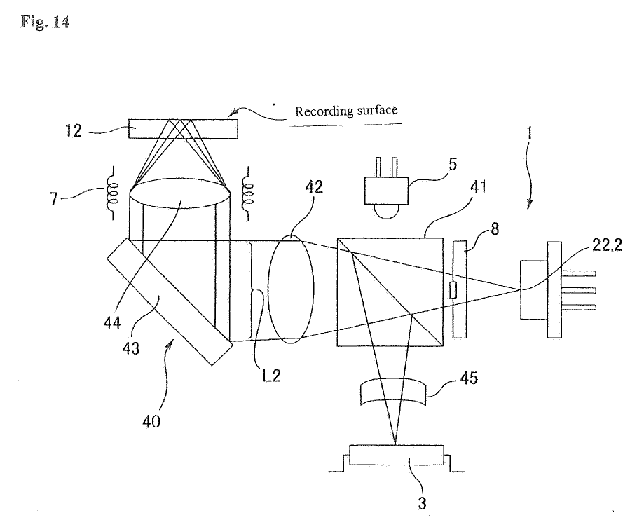

FIG. 14 comprises the explanatory diagram showing the typical construction of the essential sections of the optical recording disk apparatus relating to the Embodiment 5 of the present invention. Embodiments 1˜4 were explained with the optical recording disk apparatus that records and/or retrieves information on the CD system optical disk 11, and the DVD system optical disk 12, as the example. However, the present invention can also be applied to the optical recording disk apparatus that records and/or retrieves information on the same DVD system optical disk 12. In this case, as shown in FIG. 14, the of the optical system that is used is identical to that of Embodiment 1, except for being provided with only the semiconductor laser 22, emitting laser beam L2 having wave length of 650 nm, as the laser beam source 2 that is used; therefore, the common optical elements are labeled identically in the figure; additional explanations are omitted.

In this embodiment, the information is recorded and/or retrieved on the DVD system optical disk 12; however, even with the same DVD system, the track pitch is 1.30 μm (land 0.615 μm+groove 0.615 μm) for the DVD-RAM, the track pitch is 0.74 μm for the DVD±R; the track pitch differs for the DVD-RAM and the DVD±R. Consequently, in the DVD±R having the narrow track pitch, [the sub-spots] are formed to span a plurality of tracks; therefore, the tracking error signals can be obtained suitably by the DPP method, no matter where the sub-spots +LS, −LS are located in the tracking direction. However, in the case of the DVD-RAM, the track pitch is wide, and the sub-beams +LS, −LS cannot be formed to span a plurality of tracks; moreover, depending on the location, when attempts are made to generate tracking error signals by the DPP method, the amplitude of the SPP signals is large in comparison to that of DVD±R; suitable DPP signals are not obtained. Therefore, in this kind of optical recording disk apparatus 1, the relative locations of the main spot and the sub-spot should be prescribed with the DVD-RAM that has the wide track pitch as the standard. In other words, the optical system should have the construction wherein the sub-spots are centered at the locations shifted in the tracking direction from the center of the main spot, at the distance of 0.25 times or 0.5 times the track pitch of the DVD-RAM that has the wide track pitch.

While the foregoing description and drawings represent the present invention, it will be obvious to those skilled in the art that various changes may be made therein without departing from the true spirit and scope of the present invention.

What is claimed is:

1. An optical recording disk apparatus comprising:
a first optical disk for recording and/or retrieving information and a second optical disk having differing track pitch;
said apparatus comprising a laser beam source;
a photodetector;
an optical system constituting an outward path that conducts the laser beam emitted from the laser beam source to an optical disk, and a return path that conducts the returning beam reflected from said optical disk to the photodetector;
a tracking error signal generation circuit that generates tracking error signals by the differential push-pull method, based on the detection results from the above photodetector;
said optical system containing diffraction elements for 3-beam generation, provided with an inner diffraction region containing at least, the center section of the incident region, and an outer region with zero-order beam transmittance higher than that of the inner diffraction region, in the incident region for the laser beam emitted from the laser beam source, at a location along the outward path; and
said 3-beam member generated by the diffraction elements forming the sub-spot centered at the location shifted in the tracking direction from the center of the main spot, at the distance of 0.2 to 0.8 times the track pitch of the first optical disk that has the larger amplitude, by comparison, of the first optical disk and the second optical disk, for the sub-push pull signals used in the differential push-pull method.

2. An optical recording disk apparatus comprising:
a first optical disk for recording and/or retrieving information and a second optical disk having differing track pitch;
said apparatus comprising a laser beam source;
a photodetector;
an optical system constituting an outward path that conducts the laser beam emitted from the laser beam source to an optical disk, and a return path that conducts the returning beam reflected from this optical disk to the photodetector;
a tracking error signal generation circuit that generates tracking error signals by the differential push-pull method, based on the detection results from the above photodetector;
said optical system containing diffraction elements for 3-beam generation;
said apparatus provided with an inner diffraction region containing, at least, the center section of the incident region, and an outer region with zero-order beam transmittance higher than that of the inner diffraction region, in the incident region for the laser beam emitted from the laser beam source, at a location along the outward path; and
said 3-beam member generated by the diffraction elements generating a sub-spot centered at the location shifted in the tracking direction from the center of the main spot, at the distance of 0.2 to 0.8 times the track pitch of the first optical disk that has the wider track pitch of the two, by comparison, of the first optical disk and the second optical disk.

3. The optical recording disk apparatus as set forth in claim 1 wherein the 3-beam member generated by these diffraction elements forms the sub-spot centered at the location shifted in the tracking direction from the center of the main spot, at the distance of 0.5 times the track pitch of the first optical disk.

4. The optical recording disk apparatus as set forth in claim 2 wherein the 3-beam member generated by these diffraction elements forms the sub-spot centered at the location shifted in the tracking direction from the center of the main spot, at the distance of 0.5 times the track pitch of the first optical disk.

5. The optical recording disk apparatus as set forth in claim 1 wherein the 3-beam member generated by these diffraction elements forms the sub-spot centered at the location shifted in the tracking direction from the center of the main spot, at the distance of 0.25 or 0.75 times the track pitch of the first optical disk.

6. The optical recording disk apparatus as set forth in claim 2 wherein the 3-beam member generated by these diffraction elements forms the sub-spot centered at the location shifted in the tracking direction from the center of the main spot, at the distance of 0.25 or 0.75 times the track pitch of the first optical disk.

7. The optical recording disk apparatus as set forth in claim 1 wherein the first optical disk is a CD system disk, and as the second optical disk is a DVD system disk; the laser beam source is provided with a first laser beam source that emits the first wavelength laser beam for CD use and a second laser beam source that emits the second wavelength laser beam for DVD use; this optical system utilizes the construction wherein the outward path and the return path are constructed for common use by the first laser beam and the second laser beam.

8. The optical recording disk apparatus as set forth in claim 2 wherein the first optical disk is a CD system disk, and as the second optical disk is a DVD system disk; the laser beam source is provided with a first laser beam source that emits the first wavelength laser beam for CD use and a second laser beam source that emits the second wavelength laser beam for DVD use; this optical system utilizes the construction wherein the outward path and the return path are constructed for common use by the first laser beam and the second laser beam.

9. The optical recording disk apparatus as set forth in claim 1 wherein the diffraction elements can utilize the construction wherein the outer region comprises a non-diffraction region, in this case, the duty ratio is 50:50 in the inner diffraction region for the plurality of groove sections constituting the diffraction grating and the land sections located between the plurality of grooves; moreover, the center locations in the depth direction for the plurality of grooves constituting the diffraction grating in the inner diffraction region are preferably located at the same height as the surface of the non-diffraction region.

10. The optical recording disk apparatus as set forth in claim 2 wherein diffraction elements can utilize the construction wherein the outer region comprises a non-diffraction region, in this case, the duty ratio is 50:50 in the inner diffraction region for the plurality of groove sections constituting the diffraction grating and the land sections located between the plurality of grooves; moreover, the center locations in the depth direction for the plurality of grooves constituting the diffraction grating in the inner diffraction region are preferably located at the same height as the surface of the non-diffraction region.

11. The optical recording disk apparatus as set forth in claim 1 wherein the diffraction elements can utilize the construction wherein the outer region comprises the outer diffraction region that has diffraction efficiency lower than that of the inner diffraction region, in this case, the duty ratio is 50:50 for the plurality of groove sections constituting the diffraction grating in the inner diffraction region and the outer diffraction region, and the land sections located between the plurality of grooves and, at the same time, the center locations in the depth direction for the plurality of groove sections constituting the diffraction grating in the inner diffraction region are located at the same height as the center locations in the depth direction for the plurality of groove sections constituting the diffraction grating in the outer diffraction region.

12. The optical recording disk apparatus as set forth in claim 2 wherein the diffraction elements can utilize the construction wherein the outer region comprises the outer diffraction region that has diffraction efficiency lower than that of the inner diffraction region. In this case, the duty ratio is 50:50 for the plurality of groove sections constituting the diffraction grating in the inner diffraction region and the outer diffraction region, and the land sections located between the plurality of grooves and, at the same time, the center locations in the depth direction for the plurality of groove sections constituting the diffraction grating in the inner diffraction region are located at the same height as the center locations in the depth direction for the plurality of groove sections constituting the diffraction grating in the outer diffraction region.

13. An optical recording disk apparatus for recording and/or retrieving information on an optical disk comprising:
a laser beam source;
a photodetector;
an optical system constituting an outward path that conducts the laser beam emitted from the laser beam source to the optical disk;
a return path that conducts the returning beam reflected from said optical disk to the photodetector;
a tracking error signal generation circuit for generating tracking error signals by the differential push-pull method, based on the detection results from the above photodetector;
said optical system containing diffraction elements for 3-beam generation, provided with an inner diffraction region containing at the least, the center section of the incident region, and an outer region with zero-order beam transmittance higher than that of the inner diffraction region, at a location along the outward path in the incident region for the laser beam emitted from the laser beam source; and
said 3-beam member generated by these diffraction elements forming the sub-spot centered at the location whereto the amplitude of the sub-push-pull signals used in the differential push-pull method has been shifted, at the distance of 0.2 to 0.8 times the track pitch from the center of the main spot in the tracking direction.
